(19) United States
(12) Patent Application Publication
(10) Pub. No.: US 2009/0251996 A1
(43) Pub. Date: Oct. 8, 2009

(54) OBJECT POSITION ESTIMATION

(75) Inventor: Esko Olavi Dijk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,565

(22) PCT Filed: Feb. 24, 2005
(86) PCT No.: PCT/IB2005/050679

§ 371 Date: Sep. 5, 2006

(30) Foreign Application Priority Data
Mar. 9, 2004 (EP) 04100950.7

(51) Int. Cl. G01S 3/80; G01S 15/00; G06F 15/00

(52) U.S. Cl. 367/127; 367/99; 702/150; 702/152

(57) ABSTRACT

A system for determining the position of an object (8) in a space (10) defined by surfaces (11, 12) comprises at least a first transducer (1), a second transducer (2) and a processing device. The transducers are arranged at a mutual spacing (D). The processing device is arranged for determining the times of arrival of both acoustic signals transmitted between the object and each of the transducers (1, 2) and their reflections. On the basis of the difference in the times of arrival of clusters of acoustic signals and the associated reflections the processing device can determine which surface (11, 12) the indirect acoustic signals were reflected by, thus providing additional position information.

The present invention relates to object position estimation. More in particular, the present invention relates to a device and a system for determining the position of an object in a space defined by surfaces.

It is well known to determine the submersion depth of a submarine in sea water using the transmission time of sound signals. Using acoustic signals to determine the position of an object in air is far less common.

European Patent Application 03101098.1 describes a position estimation system for estimating a position of an object in a room using ultrasound. This system detects not only the shortest route signal but also reflection signals so as to obtain more information on the position of the object. The detected signals are compared with templates and a matching template defines the position in the room.

Although the system of European Patent Application 03101098.1 is very effective, is has the drawback that it cannot distinguish between reflections off different surfaces (that is, walls, ceiling and floor). In other words, when detecting a reflection signal the system cannot determine whether the reflection signal was reflected by a wall on the left-hand side of the room or on the right-hand side. As a result, some ambiguity with regard to the position of the object may remain.

It is an object of the present invention to overcome these and other problems of the Prior Art and to provide a device for determining the position of an object that allows the position of the object to be determined with greater accuracy.

It is another object of the present invention to provide a device for determining the position of an object that can distinguish between signals reflected by different surfaces.

It is further object of the present invention to provide a system for and a method of determining the position of an object.

Accordingly, the present invention provides a device for determining the position of an object in a space defined by surfaces, the device being arranged for cooperating with an acoustic transducer unit so as to detect acoustic signals transmitted between the object and the transducer unit including their reflections, and for deducing the position of the object from the detected acoustic signals and their reflections,
wherein the acoustic transducer unit comprises at least a first transducer and a second transducer arranged at a mutual spacing, and
wherein the device is further arranged for determining the times of arrival of the detected acoustic signals and their reflections, and for associating reflections with surfaces on the basis of the order of the times of arrival of the reflections and the correspondence of said times of arrival with the respective transducers so as to derive position information from said order.

By using at least two transducers which are spaced apart, and determining the times of arrival of the reflections of the acoustic signals, it is possible to distinguish between reflections caused by different surfaces as the times of arrival of the reflections will be determined by these surfaces. As a result, the reflections can be associated with the reflecting surfaces, that is, the surfaces can be identified that caused certain reflections. The location of these surfaces relative to the transducers provides valuable position information allowing a reliable determination of the position of the object. Additionally determining the times of arrival of the detected direct, that is non-reflected acoustic signals provides additional position information allowing the position of the object to be deduced with greater accuracy.

More in particular, the indirect, that is reflected signals associated with the first and the second transducers may arrive in reverse temporal order, depending on the reflecting surface. In this way, the relative times of arrival of the reflected signals corresponding with the first and the second transducer provide an indication of the surface causing the reflection and of the trajectory of the reflections and hence of the position of the object.

In a preferred embodiment, the device of the present invention is further arranged for detecting any reversal in the times of arrival of the reflections. That is, a reversal of the times of arrival of the reflections of the acoustic signal received at the transducers of the transducer unit, and/or a reversal of the times of arrival of the reflections of the acoustic signal produced by the transducers of the transducer unit, is used to identify the surface causing the reflection.

In an advantageous embodiment, the device is further arranged for comparing the order in which reflections of an acoustic signal are detected with the order in which the associated acoustic signal is detected. Thus, by including the direct acoustic signal, an improved comparison of the detection times is achieved and the reflection surfaces can be identified with greater accuracy, leading to a better position estimation.

In a preferred embodiment, the device of the present invention is further arranged for determining the order in which the acoustic signals are detected. That is, the order of the direct signal detection times associated with the at least two transducers is used to derive position information. It will be understood that this order is not used to identify a surface but to deduce position information directly, in particular information concerning the position of the object relative to the transducer unit, for example information indicating whether the object is positioned to the left or to the right of the transducer unit.

It is possible to determine the position of an object solely on the basis of the times of arrival of the acoustic signals and the associated reflections, as these times of arrival define the transmission paths of the acoustic signals including the reflections. However, in an advantageous embodiment the device of the present invention is further arranged for matching the detected acoustic signals with predetermined templates. In this embodiment, templates of the acoustic signals typically received in the space concerned are made and stored, and the acoustic signals and reflections detected when determining a position are matched with the templates, the best match providing an estimate of the position. This technique of template matching is described in more detail in the above-mentioned European Patent Application 03101098.1. The present invention provides a valuable addition to said template matching technique and removes any remaining ambiguities.

In a first embodiment, the transducers are arranged for detecting acoustic signals. In this embodiment, the acoustic signals could be produced by the object or by an external source. The device of the present invention is in this embodiment coupled to the transducers.

In a second embodiment, the transducers are arranged for producing acoustic signals. In this embodiment, the acoustic signals are produced by the transducers and could be detected by a further transducer (detector) located in the object of which the position is to be determined. The device of the present invention is in this embodiment suitably coupled to the object. That is, the device may be located in the object or may be coupled to the object to receive detection signals from the further transducer.

In a third embodiment, the transducers are arranged for both producing and detecting acoustic signals. In this embodiment, the acoustic signals could be produced by the transducers, be reflected or re-transmitted by the object and then be detected by the same transducers. The device of the present invention is in this embodiment coupled to the transducers and may comprise a circuit for producing suitable transducer excitation signals.

In the third embodiment, the acoustic signals produced by the two (or more) transducers can be distinguished, for example by having slightly different frequencies or containing identification signals when transmitted simultaneously, or by transmitting the acoustic signals consecutively, preferably at a predetermined time interval.

It is preferred that the acoustic signals are ultrasonic signals. By using signals which are not audible, any interference with music or any discomfort for the user is avoided. However, it is also possible to use sound signals, that is, audible signals.

In a preferred embodiment, only two transducers are used. This, however, allows the position of an object to be determined in a single plane only. In an advantageous alternative embodiment, therefore, there are at least three transducers arranged in a two-dimensional pattern so as to obtain three-dimensional position information. The pattern could for instance be a triangle or a square. Such an arrangement allows the position of an object to be determined in two orthogonal planes, that is, in three dimensions, for example by applying the present invention in each plane separately, or by directly determining the three-dimensional position of the object.

Advantageously, the device of the present invention is further arranged for determining the times of arrival of the acoustic signals and their reflections relative to the time of transmission of those signals. This provides additional information on the position of the object as the times of arrival of the direct acoustic signals relative to the respective times of transmission, and therefore the transmission times of the direct signals, are proportional of the length of the transmission paths. Dividing this transmission time by the speed of sound (in air approximately 343 m/s) gives the length of the transmission path.

The present invention further provides a system for determining the position of an object in a space defined by surfaces, the system comprising a first transducer, a second transducer and a device as defined above. The system may comprise a further transducer arranged in the object for detecting acoustic signals transmitted by the first and second transducers. It will be understood that the system may include a transducer unit which comprises more than two transducers, for example three or four.

The present invention also provides a method of determining the position of an object in a space defined by surfaces using an acoustic transducer unit, the method comprising the steps of detecting acoustic signals transmitted between the object and the transducer unit including their reflections, and deducing the position of the object from the detected acoustic signals and their reflections,
wherein the acoustic transducer unit comprises at least a first transducer and a second transducer arranged at a mutual spacing, and
wherein the times of arrival of the detected acoustic signals and their reflections are determined, and reflections are associated with surfaces on the basis of the order of the times of arrival of the reflections and the correspondence of said times of arrival with the respective transducers so as to derive position information from said order.

In addition, the present invention provides a computer program product for carrying out the method as defined above.

The present invention will further be explained below with reference to exemplary embodiments illustrated in the accompanying drawings, in which:

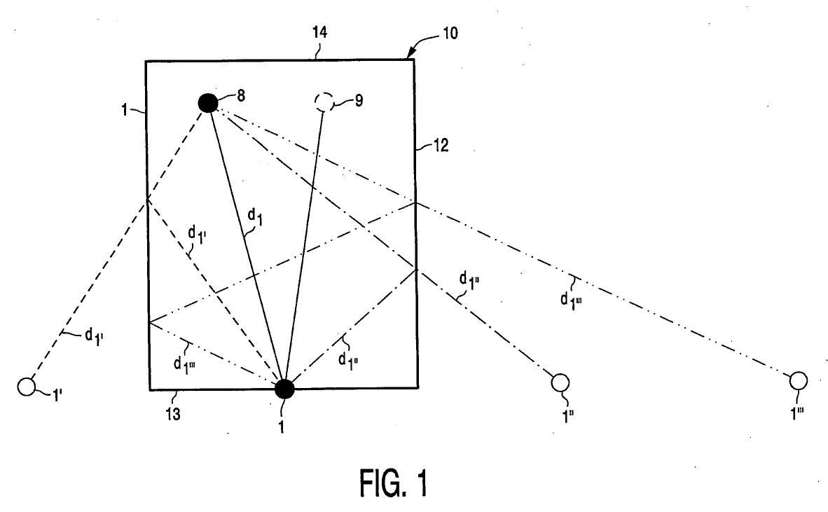

FIG. 1 schematically shows, in plan view, a room in which the position of an object is located in accordance with the Prior Art.

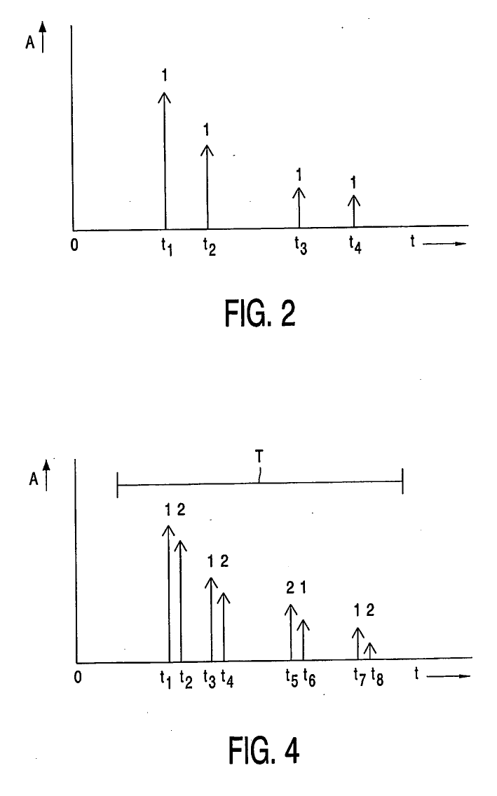

FIG. 2 schematically shows acoustic pulses and their arrival times as used in the Prior Art.

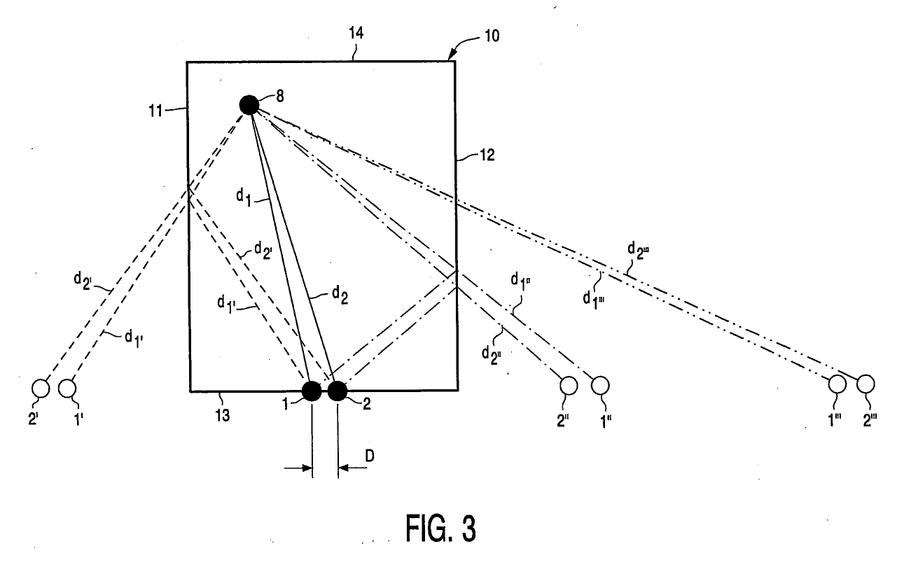

FIG. 3 schematically shows, in plan view, a room in which the position of an object is located in accordance with the present invention.

FIG. 4 schematically shows acoustic pulses and their arrival times as used in the present invention.

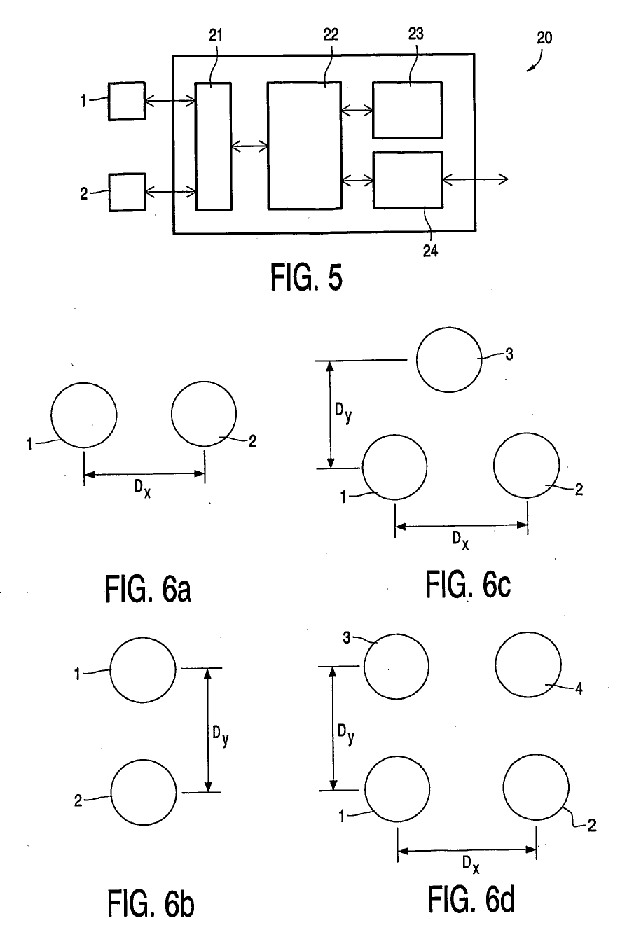

FIG. 5 schematically shows a device for determining the position of an object in accordance with the present invention.

FIG. 6 schematically shows alternative transducer arrangements in accordance with the present invention.

The room 10 shown merely by way of non-limiting example in FIG. 1 is defined by side walls 11 and 12, a front wall 13 and a back wall 14. The room may also have a ceiling and a floor which are not shown in FIG. 1 for the sake of clarity of the illustration.

In accordance with the Prior Art, a single transducer 1 is arranged in the room, in the example shown at the front wall 13. An object 8, the position of which is to be determined, is located in the room 10.

Acoustic signals (that is, sound or ultrasound signals) emitted by the object 8 will propagate in multiple directions. One such propagation path, also known as transmission path, forms the shortest route from the object 8 to the transducer 1. An acoustic signal following this “line-of-sight” path d₁ will be detected first by the transducer 1, as the alternative paths involving reflections, such as the paths d₁′ and d₁″, are longer. That is, the signal of any paths involving reflections off the side walls 11 and 12 will be slightly delayed with respect to the direct path d₁. This delay, which will later be explained in more detail with reference to FIG. 2, provides information regarding the position of the object 8.

In FIG. 1, “virtual transducers” 1′, 1″ and 1′″ are shown. Virtual transducers 1′, 1″ are mirror images of the actual transducer 1, mirrored relative to the walls 11 and 12. Virtual transducer 1′″ is itself a mirror image of the virtual transducer 1′ relative to the wall 12. These virtual transducers merely serve to clarify the geometry of the transmission paths, as it will be understood that transducer 1 is the actual transducer and that all actual transmission paths are located inside the room 10. Thus the first reflection against the left wall 11 follows the transmission path d₁′, the second reflection against the right wall 12 follows the transmission path d₁″ while the third reflection, reflecting first against the right wall 12 and then against the left wall 11, follows the transmission path d₁′″.

In FIG. 2 the amplitude (A) of detected acoustic pulses is schematically illustrated. These pulses, which are detected by the transducer 1 of FIG. 1, are detected at various points in time (t).

As can be seen in FIG. 2, each transmission path causes an acoustic signal to be detected by the transducer 1: at t₁, the transducer 1 detects the direct (“line-of-sight”) path d₁, at t₂ the first reflection via transmission path d₁′, at t₃ the second reflection via transmission path d₁″ and at t₄ the third reflection via transmission path d₁′″. These times of arrival provide valuable information on the position of the object 8. However, it is not possible to determine whether a reflection was caused by the left wall 11 or the right wall 12. As a result, the position of the object 8 as detected is ambiguous and no distinction can be made between the actual object 8 and a “phantom” object 9 which is located at the same distance as the object 8 but at a position mirrored relative to the center line of the room 10. The present invention aims to solve this problem.

In accordance with the present invention, both a first transducer 1 and a second transducer 2 are arranged at the front wall 13, as is schematically shown in FIG. 3. As before an object 8, the position of which is to be determined, is located in the room 10. It will be understood that the room 10 merely serves as an example and that the present invention can also be utilized in any other space having at least two surfaces, such as walls, a ceiling and/or a floor. The invention can therefore also be used in, for example, a space between two buildings.

In the following discussion it will be assumed that the transducers 1 and 2 receive acoustic signals emitted by the object 8. The invention is, however, not so limited and embodiments can be envisaged in which the transducers emit acoustic signals which are received, or reflected, by the object 8. Alternatively, the transducers 1 and 2 may receive acoustic signals that are emitted by another transducer (not shown) and reflected by the object 8.

Acoustic signals (that is, sound or ultrasound signals) emitted by the object 8 will again propagate in multiple directions. Two such propagation paths, also known as transmission paths, form the shortest routes from the object 8 to the transducers 1 and 2 respectively. An acoustic signal following these “line-of-sight” paths d₁ and d₂ will be detected first by the transducers 1 and 2 respectively, as the alternative paths involving reflections, such as the paths d₁′ and d₂′, are longer. That is, the signal of any paths involving reflections off the side walls 11 and 12 will be slightly delayed with respect to the direct paths d₁ and d₂. This delay, which will later be explained in more detail with reference to FIG. 4, provides information on the position of the object 8.

In the example of FIG. 3, the object 8 is located to the left of the middle of room 10, while the transducers 1 and 2 are located approximately at the center of front wall 13. As a result, the direct path d₁ is slightly shorter than the direct path d₂ and the acoustic signal from the object 8 will reach transducer 1 before it reaches transducer 2. This is schematically illustrated in FIG. 4, where the detected signal amplitude (A) is shown at various points in time (t). At t₁, transducer 1 is the first to detect a signal (path d₁), followed by transducer 2 at t₂ after a short delay. This time delay Δ=(t₂−t₁) already indicates, in the geometry of FIG. 3, that the object 8 is located to the left of the middle of room 10. It can be seen from FIG. 3 that the time delay Δ would be equal to zero if the object 8 were located in the middle of the room, opposite the transducers 1 and 2. Similarly, the time delay Δ would be negative (transducer 1 receiving the acoustic signal later than transducer 2) is the object 8 were located to the right of the middle of the room.

It is noted that this time delay Δ is due to the position of the object 8 and the spacing D of the transducers 1 and 2. In the Prior Art arrangements where only a single microphone or other transducer is used, this time delay Δ cannot be detected and consequently valuable location information is lost.

At t₃, the first transducer 1 receives a signal which has been reflected by the left side wall 11. This signal has followed the path d₁′ indicated in FIG. 3. At t₄, the second transducer 2 receives the counterpart signal which has followed the path d₂′ of FIG. 3. As shown schematically in FIG. 3, the reflections off the left wall 11 can be modeled as paths leading towards virtual transducers 1′ and 2′, the positions of which are mirror images relative to the wall 11 of the actual positions of the transducers.

Similarly, reflections off the right wall 12 can be modeled as paths d₂″ and d₁″ leading to virtual transducers 2″ and 1″ respectively, the positions of the virtual transducers being mirror images relative to the wall 12. It is noted that the path d₂″ is closer to the (actual) transducers 1 and 2 than the path d₁″ is. As a result the path d₂″ is shorter and the signal will reach the second transducer 2 first. This is shown in FIG. 4 where the second transducer 2 receives a signal at t₅, while the first transducer 1 receives the same signal at t₆. This reversal of the order of receipt is another valuable indication of the position of object 8. In particular, this reversal indicates that the signal received at t₅ and t₆ is reflected by the right wall 12 instead of the left wall 11. It is again noted that this reversal cannot be detected by arrangements having only a single transducer, or by arrangements where no spacing D is present.

As can be seen, further reflections off the right wall are possible, resulting in paths d₁′″ and d₂′″ towards virtual transducers 1′″ and 2′″ respectively (the paths d₁′″ and d₂′″ inside the room 10 are not shown for the sake of clarity of the illustration but are of course analogous to the reflections shown in FIG. 1). The positions of the virtual transducers 1′″ and 2′″ are the mirror image relative to the wall 12 of the positions of virtual transducers 1′ and 2′ respectively. These further reflections are received at t₇ and t₈ (FIG. 4) respectively. Although further signals (not shown) resulting from further reflections may also be used, it is preferred to use the first three or four pairs of signals (for example the first eight points in time t₁-t₈) only. The time interval T in which the acoustic signals are detected therefore extends so as to include at least the first and the second reflection pairs, and preferably also the third reflection pair. It is noted that the time interval T may start at a common reference point in time t₀ (denoted 0 in FIG. 4) to produce “absolute” times of arrival, the point in time to preferably being the moment of transmission of the acoustic pulses. Those skilled in the art will be able to utilize known mechanisms providing time synchronization of the transducers 1 and 2 when used as signal detectors on the one hand and any transmitting transducer in the object on the other hand, so as to establish the common reference point in time. For example, the transmitted signals could be provided with a time stamp consisting of, for example, a code word (digital) or a code signal (analog). Alternatively, received signals could be re-transmitted so as to provide a transmission time indication.

In FIG. 4 it is indicated by which transducer each signal is received. The “normal” order being 1-2, it can be seen that the second reflections, received at t₅ and t₆, are received in reverse order due to the transmission paths involving the right wall 12. Using the order in which the signals are received, it can therefore be determined that the signal pair received at t₁ and t₂ are direct path signals, that the signals received at t₃ and t₄ are indirect signals reflected by the left wall 11 and that the signals received at t₅ and t₆ are indirect signals reflected by the right wall 12.

When the geometry of the room 10 is known, it is possible to determine the location of the object 8 on the basis of the times of arrival t₁ to t₈. In particular, the relative time differences t₃-t₁ and t₆-t₁ provide information on the lengths of the paths d₁, d₁′ and d₁″. Identifying the reflecting surfaces on the basis of the order in which the reflections are detected indicates the general direction of these paths. Using well-known geometric formulae, the position of the object 8 may then be unambiguously determined.

Although it is possible to determine the position of the object 8 solely on the basis of the times of arrival of the detected acoustic pulses and their reflections, it is preferred to additionally use template matching of the detected signals and reflections. This involves making templates of the received acoustic signals and their reflections for a large number of possible positions in the room 10 and storing these templates. When determining the position of an object in the room, the signal amplitudes (envelope) of the received signals are compared with the stored templates. The stored position corresponding with the best match is the desired position. This technique is described in more detail in the above-mentioned European Patent Application 03101098.1, the entire contents of which are hereby incorporated in this document.

It is noted that the comparison carried out in the above-mentioned template matching method may involve a simple subtraction or a least-squares comparison but preferably a correlation of each acoustic signal with a plurality of templates. The mathematical technique of correlation is well known and needs no further explanation. The template having the highest, that is “best” correlation with a certain detected acoustic signal is selected. As the object position corresponding with the particular template is previously stored, this position is then retrieved to yield the determined object position.

It has been found that the present invention, when used in addition to template matching, provides a significant improvement of the method of European Patent Application 03101098.1. In particular, the said method may produce ambiguous results in the presence of noise and/or when a large number of reflections is detected. The present invention removes these ambiguities by providing additional position information which may be suitably combined with the position information provided by the template matching method to yield an accurate position determination. In a particularly advantageous embodiment, therefore, a template matching is carried out, providing a “shortlist” of not one but a (small) number of best matches (that is, matching templates), for example three, five, or ten. A position determination according to the present invention is also carried out, yielding an additional determined position. This additional position (based on the reflection detection order) is then compared with the above-mentioned “shortlist” to select the best template-based position corresponding with the additional reflection-based position. It will be clear that this combined method provides an excellent possibility for error checking: when there is no template-based position that corresponds with a reflection-based position, an error must have been made. Such errors may be due to noise, moving other objects in the space concerned, and other causes.

The example of FIGS. 3 and 4 involves position detection in a plane, that is, in two dimensions. It will be understood that the present invention can also be utilized for three-dimensional position detection, as will later be explained with reference to FIGS. 6a-d.

A device for determining the position of an object in a room is schematically shown in FIG. 5. The exemplary device 20 comprises an interface unit 21, a processor unit 22, a memory unit 23 and an input/output (I/O) unit 24. A first transducer 1 and a second transducer 2 are coupled to the device 20 via the interface unit 21 which provides suitable signal conversions. The processor unit 22 preferably comprises a microprocessor capable of executing computer programs stored in memory unit 23. In addition to computer programs for e.g. template matching and/or signal processing, the memory unit 23 may also store templates. A computer program may be loaded into the memory unit 23 from a suitable carrier device such as a CD or DVD.

The transducers may be used for detecting acoustic signals, producing acoustic signals, or both. In one embodiment, the transducers 1 and 2 produce acoustic signals containing an identification, such as a (digital) code word, or a particular unique frequency. The object 8 may, in that particular embodiment, contain a single transducer and may further contain the device 20 or, alternatively, transmission means for transmitting the signals produced by the transducers to a remote device 20. Embodiments can be envisaged in which the transducer unit containing the transducers 1 and 2 as well as the device 20 are accommodated in the object 8, and in which a single transducer is mounted on a wall of the room 10.

Suitable transducer arrangements in accordance with the present invention are schematically shown in FIGS. 6a-d. In the example of FIG. 6a, the transducers 1 and 2 are positioned at a horizontal spacing Dₓ, while in FIG. 6b the transducers 1 and 2 are arranged vertically at a spacing D_{y}. Either arrangement allows the position of an object to be determined in a single (horizontal or vertical) plane only. The two-dimensional arrangement of FIG. 6c allows a position to be determined in both the horizontal and the vertical plane using three transducers 1, 2 and 3. The horizontal spacing Dₓ and the vertical spacing D_{y} may also be achieved by an arrangement of four transducers 1-4 as shown in FIG. 6d. It will be understood that other arrangement are also possible. For instance, more than two transducers could be used in any plane, such as an arrangement of three or four transducers in line. Such an arrangement provides more timing information at the cost of additional transducers. It will be understood that the present invention can be practiced using only two transducers in any plane.

Although the transducers 1 and 2 in FIG. 3 are arranged in the plane of the front wall 13, this is not essential and the plane in which the transducers lie could be situated at an acute or even right angle relative to the front wall 13. It will be understood that the transducers 1 and 2 can also be placed on other walls or surfaces.

The present invention is based upon the insight that using two transducers which are spaced apart allows reflections off surfaces to be identified on the basis of their relative time delays. The present invention benefits from the further insight that the reflections of acoustics signals can be used to determine the position of an object in a room.

Under computer program product should be understood any physical realization, e.g. an article of manufacture, of a collection of commands enabling a processor—generic or special purpose—, after a series of loading steps to get the commands into the processor, to execute any of the characteristic functions of an invention. In particular the computer program product may be realized as program code, processor adapted code derived from this program code, or any intermediate translation of this program code, on a carrier such as e.g. a disk or other plug-in component, present in a memory, temporarily present on a network connection—wired or wireless—, or program code on paper. Apart from program code, invention characteristic data required for the program may also be embodied as a computer program product.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. A device (20) for determining the position of an object (8) in a space (10) defined by surfaces (11, 12), the device being arranged for cooperating with an acoustic transducer unit so as to detect acoustic signals transmitted between the object and the transducer unit including their reflections, and for deducing the position of the object from the detected acoustic signals and their reflections,
wherein the acoustic transducer unit comprises at least a first transducer (1) and a second transducer (2) arranged at a mutual spacing (D), and
wherein the device (20) is further arranged for determining the times of arrival of the detected acoustic signals and their reflections, and for associating reflections with surfaces (11, 12) on the basis of the order of the times of arrival of the reflections and the correspondence of said times of arrival with the respective transducers (1, 2) so as to derive position information from said order.

2. The device according to claim 1, further arranged for detecting any reversal in the times of arrival of the reflections.

3. The device according to claim 1, further arranged for comparing the order in which reflections of an acoustic signal are detected with the order in which the associated acoustic signal is detected.

4. The device according to claim 1, further arranged for determining the order in which the acoustic signals are detected.

5. The device according to claim 1, further arranged for matching the detected acoustic signals with predetermined templates.

6. The device according to claim 1, wherein the transducers (1, 2) are arranged for detecting acoustic signals.

7. The device according to claim 1, wherein the transducers (1, 2) are arranged for producing acoustic signals.

8. The device according to claim 1, wherein the acoustic signals are ultrasonic signals.

9. The device according to claim 1, wherein the transducer unit comprises at least three transducers (1, 2, 3) arranged in a two-dimensional pattern so as to obtain three-dimensional position information.

10. The device according to claim 1, further arranged for determining the times of arrival (t1, t2, t3, t4, . . . ) of the acoustic signals and their reflections relative to the time of transmission of those signals.

11. A system for determining the position of an object in a space defined by surfaces (11, 12), the system comprising a first transducer (1), a second transducer (2) and a device (20) according to claim 1.

12. A method of determining the position of an object (8) in a space (10) defined by surfaces (11, 12) using an acoustic transducer unit, the method comprising the steps of detecting acoustic signals transmitted between the object and the transducer unit including their reflections, and deducing the position of the object from the detected acoustic signals and their reflections,
wherein the acoustic transducer unit comprises at least a first transducer (1) and a second transducer (2) arranged at a mutual spacing (D), and
wherein the times of arrival of the detected acoustic signals and their reflections are determined, and reflections are associated with surfaces (11, 12) on the basis of the order of the times of arrival of the reflections and the correspondence of said times of arrival with the respective transducers (1, 2) so as to derive position information from said order.

13. The method according to claim 12, further comprising the step of detecting any reversal in the times of arrival of the reflections.

14. The method according to claim 12, further comprising the step of comparing the order in which reflections of an acoustic signal are detected with the order in which the associated acoustic signal is detected.

15. The method according to claim 12, further comprising the step of determining the order in which the acoustic signals are detected.

16. The method according to claim 12, further comprising the step of matching the detected acoustic signals with predetermined templates.

17. The method according to claim 12, wherein the transducers (1, 2) are arranged for detecting acoustic signals.

18. The method according to claim 12, wherein the transducers (1, 2) are arranged for producing acoustic signals.

19. The method according to claim 12, wherein the acoustic signals are ultrasonic signals.

20. The method according to claim 12, wherein the transducer unit comprises at least three transducers (1, 2, 3) arranged in a two-dimensional pattern so as to obtain three-dimensional position information.

21. The method according to claim 12, further comprising the step of determining the times of arrival (t1, t2, t3, t4, . . . ) of the acoustic signals and their reflections relative to the time of transmission of those signals.

22. A computer program product for carrying out the method according to claim 12.
